(19) United States
(12) Patent Application Publication
(10) Pub. No.: US 2024/0370029 A1
(43) Pub. Date: Nov. 7, 2024

(54) METHODS AND APPARATUS FOR PRIORITIZING SUPERVISORY REQUESTS FOR AUTONOMOUS VEHICLES

(71) Applicant: Nuro, Inc., Mountain View, CA (US)

(72) Inventors: Xiaojie ZHANG, Saratoga, CA (US); Jia PU, Menlo Park, CA (US); Zetong (Tina) JIA, San Francisco, CA (US); Ashwin Shekar PATHI, Mountain View, CA (US); Minlin ZHANG, Sunnyvale, CA (US)

(73) Assignee: Nuro, Inc., Mountain View, CA (US)

(21) Appl. No.: 18/649,937

(22) Filed: Apr. 29, 2024

Related U.S. Application Data
(60) Provisional application No. 63/464,470, filed on May 5, 2023.

(51) Int. Cl. G05D 1/227; H04L 67/12; H04W 24/10

(52) U.S. Cl. CPC G05D 1/227; H04L 67/12; H04W 24/10

(57) ABSTRACT

According to one aspect, a method includes obtaining a first supervisory request from a first vehicle. The first supervisory request is processed by a teleoperations monitor arrangement. The method includes determining a first priority for the first supervisory request. After determining the first priority, the first supervisory request is added to a queue according to the first priority. The queue includes at least a second supervisory request having a second priority. Finally, the method includes determining whether the first priority is higher than the second priority. When it is determined that the first priority is higher than the second priority, the first supervisory request is processed before the second supervisory request. The first supervisory request is obtained from the queue and processed by the teleoperations monitor arrangement. Processing the first supervisory request includes determining whether the first vehicle is to be remotely operated by the teleoperations operator arrangement.

### PRIORITY CLAIM

This patent application claims the benefit of priority under 35 U.S.C. § 119 to U.S. Provisional Patent Application No. 63/464,470, filed May 5, 2023, and entitled “METHODS AND APPARATUS FOR PRIORITIZING SUPERVISORY REQUESTS FOR AUTONOMOUS VEHICLES,” which is incorporated herein by reference in its entirety.

### TECHNICAL FIELD

The disclosure relates to providing systems for use with autonomous vehicles. More particularly, the disclosure relates to systems which provide teleoperations monitoring and operational support for autonomous vehicles, and the prioritization of requests for teleoperations monitoring and operational support.

### BACKGROUND

Fleets of autonomous or semi-autonomous vehicles often utilize remote operators, e.g., operators of teleoperations systems or operator of remote controls. An operator of a teleoperations system must generally keep an eye on a display screen which depicts the environment around the vehicle that the operator is monitoring, and be ready to take control if needed, as for example when the vehicle may not operate safely in autonomous mode. When the operator takes control of the vehicle, the operator uses the teleoperations system to remotely operate the vehicle. While the use of a teleoperations system to remotely operate a vehicle is effective and enables the vehicle to operate safely when the vehicle is unable to operate autonomously, the use of a teleoperations system that is substantially dedicated to a single vehicle at any given time may be an inefficient use of resources.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a diagrammatic representation of a teleoperations monitoring and operations platform which includes a teleoperations queue within which a vehicle of a fleet of vehicles may request teleoperations monitoring in accordance with an embodiment.

FIG. 5 is a process flow diagram which illustrates a method of operating a teleoperations monitoring and operations platform will be described in accordance with an embodiment.

FIG. 6 is a process flow diagram which illustrates a method of prioritizing supervisory requests associated with a vehicle in accordance with an embodiment.

FIG. 7 is a process flow diagram which illustrates a method of a teleoperations system obtaining and processing a supervisory request associated with a vehicle, e.g., step 517 of FIG. 5, in accordance with an embodiment.

FIG. 8 is a block diagram representation of an overall system that prioritizes supervisory requests for handling by a teleoperations monitor arrangement in accordance with an embodiment.

FIG. 9 is a process flow diagram which illustrates a method of a teleoperations monitor arrangement utilizing a buffer/queue of supervisory requests in accordance with an embodiment.

FIG. 10 is a process flow diagram which illustrates a method of reprioritizing supervisory requests in a buffer/queue in accordance with an embodiment.

### DESCRIPTION OF EXAMPLE EMBODIMENTS

### General Overview

According to one aspect, a method includes obtaining a first supervisory request from a first vehicle, the supervisory request being a request to monitor the first vehicle, and determining whether to determine a priority level for the first supervisory request. The method also includes processing the first supervisory request when it is determined that the priority level for the first supervisory request is not to be determined. The first supervisory request is processed by a teleoperations monitor arrangement, and wherein processing the first supervisory request includes determining whether the first vehicle is to be remotely operated by a teleoperations operator arrangement. When it is determined that the priority level for the first supervisory request is to be determined, the method includes determining a first priority for the first supervisory request. After determining the first priority, the first supervisory request is added to a queue according to the first priority, wherein the queue includes at least a second supervisory request having a second priority. Finally, the method includes determining whether the first priority is higher than the second priority, wherein when it is determined that the first priority is higher than the second priority, the first supervisory request is processed before the second supervisory request. The first supervisory request is obtained from the queue by the teleoperations monitor arrangement and processed by the teleoperations monitor arrangement.

In accordance with another embodiment, a platform includes at least a first vehicle and an apparatus that includes one or more processors and one or more memory resources storing logic that, when executed by the one or more processors, is operable to cause the platform to obtain a first supervisory request from the first vehicle, the supervisory request being a request to monitor the first vehicle. The logic is also operable to determine whether to determine a priority level for the first supervisory request and, when it is determined that the priority level for the first supervisory request is not to be determined, processing the first supervisory request, wherein the first supervisory request is processed by a teleoperations monitor arrangement, and wherein processing the first supervisory request includes determining whether the first vehicle is to be remotely operated by a teleoperations operator arrangement. When it is determined that the priority level for the first supervisory request is to be determined, the logic is operable to determine a first priority for the first supervisory request. After determining the first priority, the first supervisory request is added to a queue according to the first priority, the queue including at least a second supervisory request having a second priority. Finally, the logic is operable to determine whether the first priority is higher than the second priority, wherein when it is determined that the first priority is higher than the second priority, the logic is operable to process the first supervisory request before the second supervisory request, the first supervisory request being obtained from the queue by the teleoperations monitor arrangement and processed by the teleoperations monitor arrangement, wherein processing the first supervisory request includes determining whether the first vehicle is to be remotely operated by the teleoperations operator arrangement.

According to yet another aspect, an apparatus includes a processor, a memory including a queue, and one or more tangible non-transitory, computer-readable medium having logic encoded thereon. The logic, when executed by the processor, is operable to obtain a first supervisory request from a first vehicle, the supervisory request being a request to monitor the first vehicle, and to determine a first priority for the first supervisory request. The logic is also operable to add the first supervisory request to the queue based on the first priority, wherein the queue includes at least a second supervisory request, the second supervisory request having a second priority. When the first priority is higher than the second priority, the logic is operable to select the first supervisory request for processing before the second supervisory request, wherein the logic operable to select the first supervisory request for processing is further operable to process the first supervisory request by determining whether the first vehicle is to be remotely operated by the teleoperations operator arrangement. Finally, when it is determined that the first vehicle is to be remotely operated by the teleoperations operator arrangement, the logic is operable to provide a first notification to the teleoperations operator arrangement and the first vehicle, the first notification being arranged to indicate that the teleoperations operator arrangement is to remotely operate the first vehicle.

In one embodiment, a platform may include a teleoperations monitor, a teleoperations system, and one or more vehicles which are capable of operating autonomously and under the control of the teleoperations system. While operating autonomously, a vehicle may encounter an issue for which the vehicle may request monitoring by the teleoperations monitor. The vehicle may create a first supervisory request for the teleoperations monitor, or for an overall systems that includes the teleoperations monitor. In the event that the vehicle encounters another issue prior to the teleoperations monitor servicing the first supervisory request, the vehicle may create a second supervisory request. If the second supervisory request is determined to be more critical than the first supervisory request, the vehicle may prioritize the second supervisory request over the first supervisory request such that when the teleoperations monitor is able to service a supervisory request associated with the vehicle, the teleoperations monitor will service the second supervisory request before the first supervisory request.

### DESCRIPTION

Teleoperations systems are often used to support the operation of autonomous and semi-autonomous vehicles. For example, an autonomous vehicle may be monitored using a teleoperations system such that if the vehicle encounters an issue while operating autonomously, the teleoperations system may be used by a remote operator to control the vehicle. Typically, a single teleoperations system may be used to monitor and to take control of a single vehicle at any given time.

While having a dedicated teleoperations system that enables an operator to remotely drive a vehicle of a fleet of autonomous vehicles allows each vehicle to operate safely in the event that autonomous mode is not possible, the use of dedicated teleoperations systems may be an inefficient use of resources. When a vehicle is capable of operating in an autonomous mode for a majority of the time that the vehicle is in use, the allocation of a dedicated teleoperations system and a dedicated teleoperator may be inefficient. In addition, for relatively large fleets of autonomous vehicles, obtaining and maintaining the number of dedicated telcoperations systems needed to facilitate the same deployment of the autonomous vehicles may be impractical.

By enabling multiple vehicles which are operating in an autonomous mode to be monitored using a single teleoperations monitoring station and, when remote operation of one of the vehicles is desired, assigning control to a teleoperations operating station, vehicles may be monitored while enabling resources to be allocated efficiently. A single teleoperations monitoring station or arrangement may include one or more display screens which enable multiple vehicles to be monitored. When a teleoperations monitor, e.g., a person responsible for using a teleoperations monitoring arrangement to monitor or otherwise keep watch on multiple vehicles, determines that a vehicle would benefit from being remotely operated, the teleoperations monitor may effectively assign control of the vehicle to a teleoperations operator, e.g., a person responsible for using a teleoperations operator arrangement to remotely control the vehicle. As such, multiple vehicles may be monitored by one teleoperations monitor and, when one of the multiple vehicles may need to be remotely operated, the teleoperations operator may cause a teleoperations operator to effectively take control of the vehicle.

In one embodiment, when a vehicle anticipates a situation in which remote operation of the vehicle by a telcoperator using a teleoperations operator arrangement may be desired, the vehicle may send or otherwise provide a supervisory request to a teleoperations monitor arrangement, and await action by the teleoperations monitor arrangement to determine whether a teleoperations operator is to take control of the vehicle using the teleoperations operator arrangement, or whether the vehicle may operate autonomously. When the vehicle has more than one situation for which a supervisory request is generated, and, hence, initiates more than one supervisory request, the supervisory requests may be prioritized by the vehicle and/or a teleoperations monitor arrangement. A first supervisory request may be issued and a second, subsequent supervisory request may be issued before the first supervisory request is processed. If the second supervisory request is deemed to have a higher priority than the first supervisory request, the second supervisory request may be prioritized over the first supervisory request for processing such that a teleoperations monitor will essentially review or address the second supervisory request before the first supervisory request using a teleoperations monitor arrangement. The priority of each supervisory request may be determined by the vehicle that issues or initiates each supervisory request.

A single teleoperations monitoring station or arrangement may include a display screen which may be used to monitor a vehicle when the vehicle requests monitoring, e.g., issues or initiates a supervisory request. When a teleoperations monitor, e.g., an individual responsible for using a teleoperations monitor arrangement to monitor a vehicle in response to a supervisory request, determines that a vehicle would benefit from being remotely operated, the teleoperations monitor may effectively assign control of the vehicle to an available teleoperations operator, e.g., a person responsible for using a teleoperations operator arrangement to remotely control the vehicle, using the teleoperations monitoring arrangement.

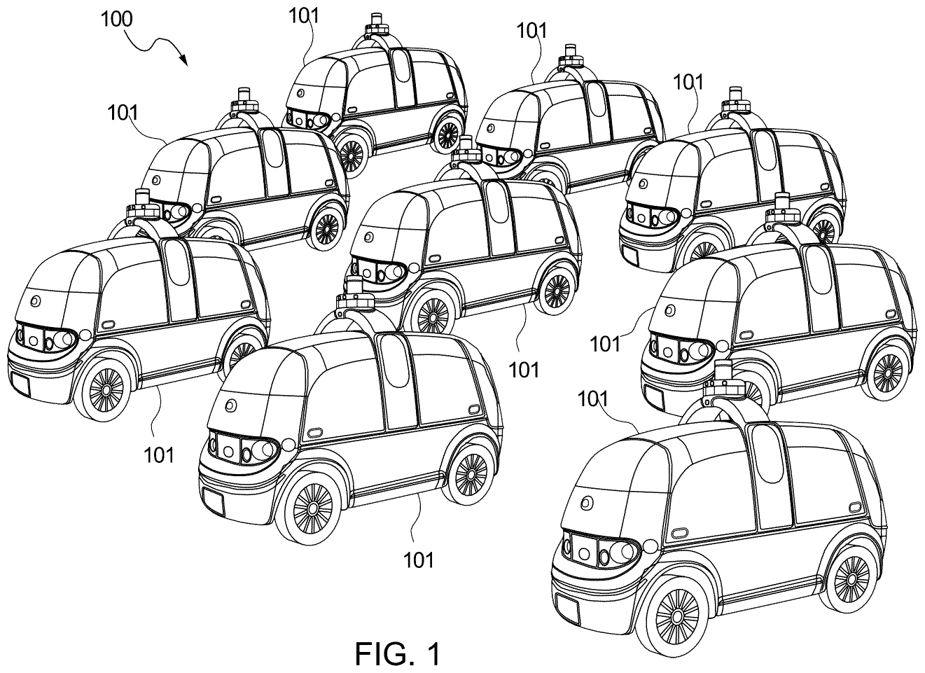

A platform which includes at least one teleoperations monitoring arrangement and one or more teleoperations operator arrangements may include a fleet of vehicles capable of operating in fully autonomous and/or semi-autonomous modes. Each vehicle may be arranged to self-monitor, e.g., to determine when there may be a situation for which a supervisory request to a teleoperations monitor may be prudent. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

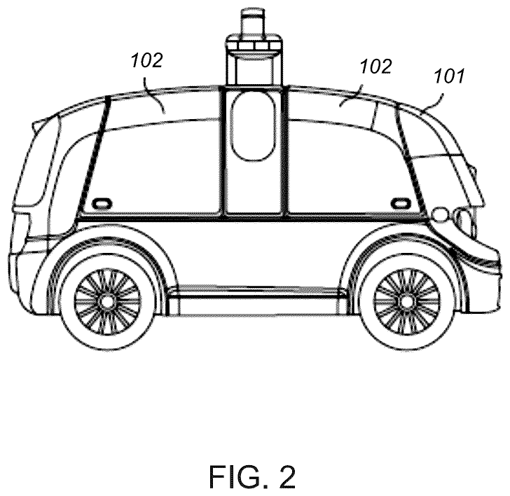

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

Although the fleet of autonomous vehicles 101 are shown as being occupantless vehicles, it should be understood that the fleet is not limited to including occupantless autonomous vehicles 101. The fleet may also, or alternatively, include autonomous vehicles configured to carry occupants.

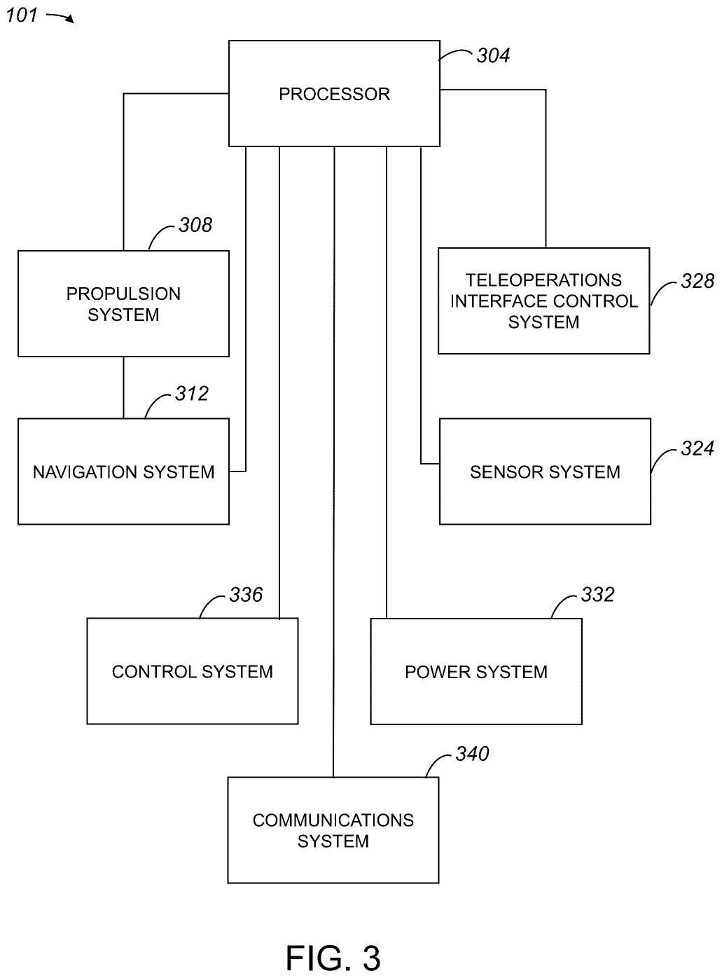

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a teleoperations interface control system 328, a power system 332, a control system 336, and a communications system 340. It should be appreciated that processor 304, propulsion system 308, navigation system 312, sensor system 324, teleoperations interface control system 328, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Teleoperations interface control system 328 generally enables vehicle 101 to be controlled remotely, as for example by a teleoperations operator arrangement. That is, teleoperations interface control system 328 enables vehicle 101 to operate by obtaining and processing instructions provided by a teleoperations operator arrangement. Additionally, teleoperations interface control system 328 may enable vehicle 101 to determine when vehicle 101, while operating autonomously, may benefit from being controlled via teleoperations and to request remote monitoring and/or control by a teleoperator. In one embodiment, teleoperations interface control system 328 enables vehicle 101 to communicate with a teleoperations monitor arrangement, a teleoperations operator arrangement, and/or a teleoperations queue. A teleoperations monitor arrangement, a teleoperations operator arrangement, and a teleoperations queue will be discussed below.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate fully autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

A teleoperations monitoring and operations platform may generally include a fleet of vehicles which are capable of operating autonomously and operating while controlled remotely, e.g., through teleoperations, at least one monitoring system which enables multiple vehicles to be monitored substantially simultaneously, and one or more teleoperations systems which enable vehicles to be teleoperated. It should be appreciated that the fleet of vehicles may include both vehicles that are not generally arranged to transport occupants and vehicles that may transport occupants. Vehicles in the fleet of vehicles may be self-monitoring, and may request monitoring or supervision from the at least one monitoring system.

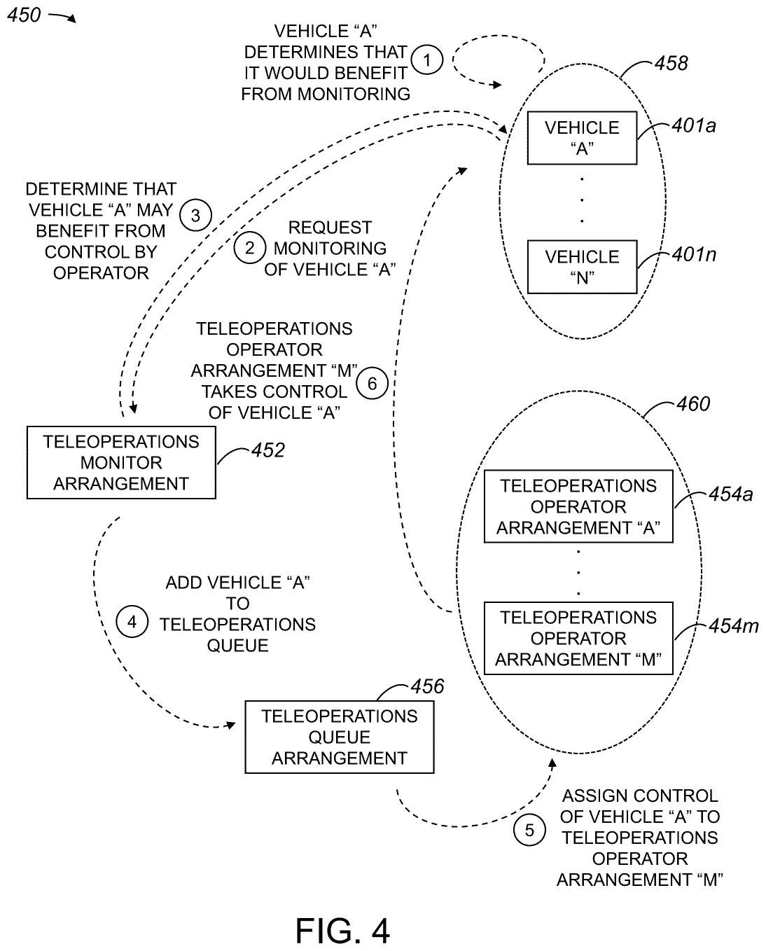

In one embodiment, a teleoperations monitoring and operations platform may include at least one teleoperations monitoring arrangement and a teleoperations queue arrangement, and be configured to support a fleet of vehicles in which vehicles that are substantially self-monitoring. FIG. 4 is a diagrammatic representation of a teleoperations monitoring and operations platform which includes a teleoperations queue within which a vehicle of a fleet of vehicles may request teleoperations monitoring in accordance with an embodiment.

A teleoperations monitoring and operations platform 450 includes a fleet 458 of vehicles 401a-n which are capable of operating autonomously, a teleoperations monitor arrangement 452, a group 460 of teleoperations operator arrangements 454a-m, and a teleoperations queue arrangement 456. Vehicles 401a-n may each generally include the components and functionality described above with respect to vehicle 101 of FIGS. 2 and 3. The number of vehicles 401a-n included in fleet 458 may vary widely. In the described embodiment, vehicles 401a-n are substantially self-monitoring. That is, vehicles 401a-n may monitor themselves and request external monitoring from teleoperations monitor arrangement 452 if needed.

At a time t1, vehicle “A” 401a, while self-monitoring or otherwise diagnosing issues it faces, determines that external monitoring by teleoperations monitor arrangement 452 is desired. As such, at a time t2, vehicle “A” 401a requests monitoring from teleoperations monitor arrangement 452. The request may include an indication of one or more issues to be monitored on vehicle “A” 401a, and an instruction that effectively specifies that the one or more issues are to be monitored. It should be appreciated that teleoperations monitor arrangement 452 may utilize a queue that prioritizes requests for monitoring. In one embodiment, vehicle “A” 401a may store the request for monitoring, or supervisory request, in a buffer and add a flag to a queue of requests for monitor which indicates to teleoperations monitor arrangement 452 that vehicle “A” 401a has one or more supervisory requests.

Teleoperations monitor arrangement 452 begins monitoring vehicle “A” 701a and determines at a time t3 that vehicle “A” 401 may benefit from control by an operator using a teleoperations operator arrangement 454a-m. By way of example, after monitoring vehicle “A” 401a, teleoperations operator arrangement 454a-m may identify an issue which may be mitigated using a teleoperations operator arrangement 454a-m.

At a time t4, teleoperations monitor arrangement 452 effectively adds vehicle “A” 401a to a queue maintained by teleoperations queue arrangement 456. In one embodiment, vehicle “A” 401a is added to the queue based on a priority identified by vehicle “A” 401a. Teleoperations queue arrangement 456 may identify a suitable teleoperations operator arrangement 454a-m to substantially take control of vehicle “A” 401a. At a time t5, teleoperations queue arrangement 456 identifies teleoperations operator arrangement 454m as suitable for substantially taking control of vehicle “A” 401a and causes transfer of control for vehicle “A” 401a to teleoperations operator arrangement 454m.

Teleoperations operator arrangement 454a takes control of vehicle “A” 401 at a time t6. When teleoperations operator arrangement 454m takes control of vehicle “A” 401a, teleoperations operator arrangement 454m may command vehicle “A” 401a to operate remotely.

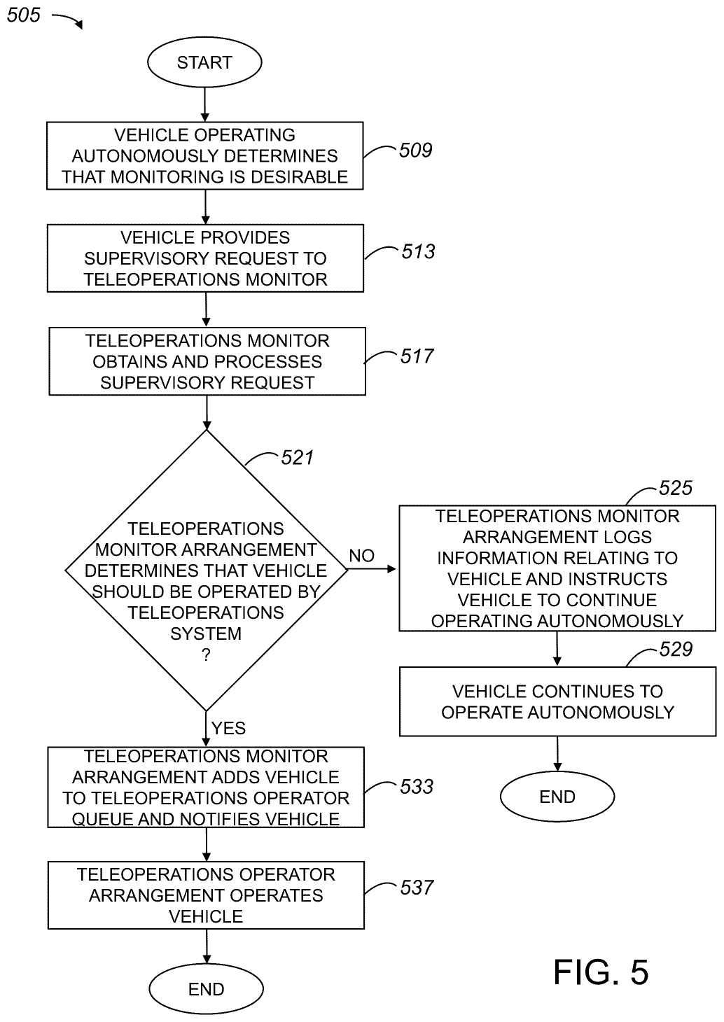

With reference to FIG. 5, a method of operating a teleoperations monitoring and operations platform, e.g., platform 450 of FIG. 4, will be described in accordance with an embodiment. A method 505 of operating a teleoperations monitoring and operations platform begins at a step 509 in which a vehicle that is operating autonomously determines that monitoring by a teleoperations monitor arrangement is desirable. The vehicle may make such a determination, for example, when self-monitoring to identify issues or situations for which monitoring by a teleoperations monitor arrangement may facilitate the safe operation of the vehicle.

Once the vehicle determines that monitoring is desirable, the vehicle generates a supervisory request and provides the supervisory request to a teleoperations monitor arrangement in a step 513. In one embodiment, the vehicle may create and add a supervisory request to a queue of requests that is associated with a teleoperations monitor arrangement. It should be appreciated that providing the supervisory request to a teleoperations monitor arrangement may include transmitting the request using a wireless network such as a cellular network. In another embodiment, the vehicle may create and add a supervisory request to a buffer on the vehicle, while adding an indication such as a to a queue of requests that is associated with a teleoperations monitor arrangement which effectively signals the teleoperations monitor arrangement to check the buffer on the vehicle for one or more supervisory requests.

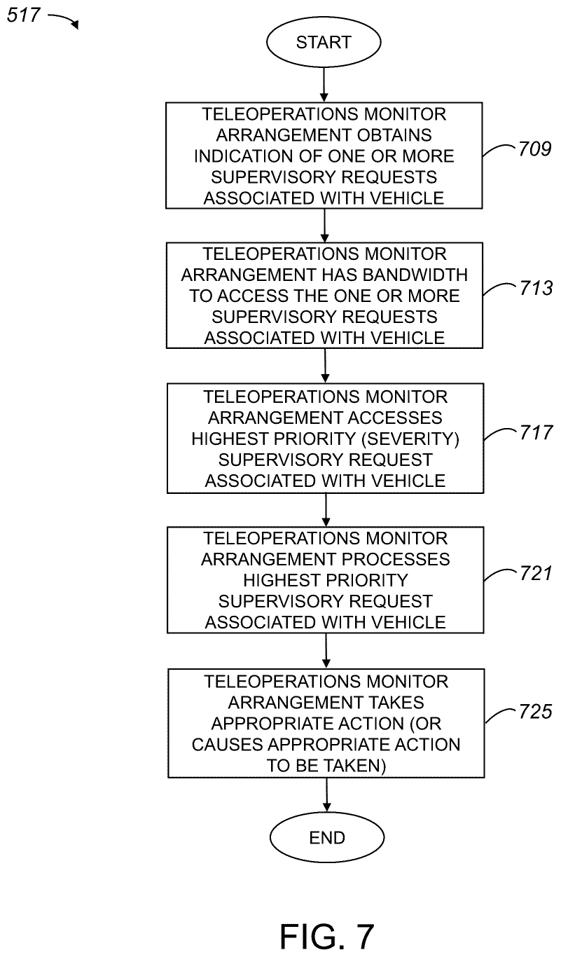

In a step 517, the teleoperations monitor arrangement obtains and processes, e.g., assesses, the supervisory request. The teleoperations monitor arrangement may obtain and process the supervisory request based on priorities associated with requests contained in a queue of supervisory requests or a monitor queue. The priorities may be based on factors which include, but are not limited to including, severity levels of issues associated with the supervisory requests. In one embodiment, the priorities of the supervisory requests may be specified by the one or more vehicles that initiates the supervisory requests. Processing the supervisory requests typically includes, but is not limited to including, monitoring the vehicle itself, monitoring the environment around the vehicle, and monitoring conditions encountered by the vehicle. In one embodiment, the supervisory request may specify a particular issue to monitor, and processing the supervisory request may include checking or otherwise observing the vehicle with respect to the particular issue. One method of obtaining and processing a supervisory request will be discussed below with reference to FIG. 7.

A determination is made in a step 521 as to whether the teleoperations monitor arrangement determines that the vehicle should be operated by a teleoperations system. In other words, it is determined in step 521 if a prudent course of action is for the vehicle to be remotely controlled by a teleoperations operator arrangement.

If the determination in step 521 is that the vehicle is not to be operated by a teleoperations system, the implication is that the vehicle may operate safely in an autonomous manner without intervention from a teleoperations system. Accordingly, in a step 525, the teleoperations monitor arrangement logs information relating to the vehicle, and instructs the vehicle to continue to operate autonomously. Then, in a step 529, the vehicle continues to operate autonomously, and the method of operating a teleoperations monitoring and operations platform is completed.

Alternatively, if it is determined in step 521 that intervention by a teleoperations system is desirable, process flow proceeds to a step 533 in which the teleoperations monitor arrangement adds the vehicle to a teleoperations operator queue which may be used to effectively assign a teleoperations operator arrangement to remotely control the vehicle. The teleoperations monitor arrangement may also notify the vehicle that the vehicle is effectively being added to a teleoperations operator queue. In one embodiment, adding the vehicle to the teleoperations operator queue includes adding contextual information associated with the vehicle to provide a teleoperations operator arrangement with situational awareness. The contextual information may include, for example, information which identifies an issue or a situation the vehicle is confronted with and an indication of why remote operation of the vehicle is requested, a hardware version associated with the vehicle, and/or a software version associated with the vehicle.

From step 533, process flow proceeds to a step 537 in which a teleoperations operator arrangement is used to remotely operate the vehicle. Once the teleoperations operator arrangement takes control of the vehicle, the method of operating a teleoperations monitoring and operations platform is completed.

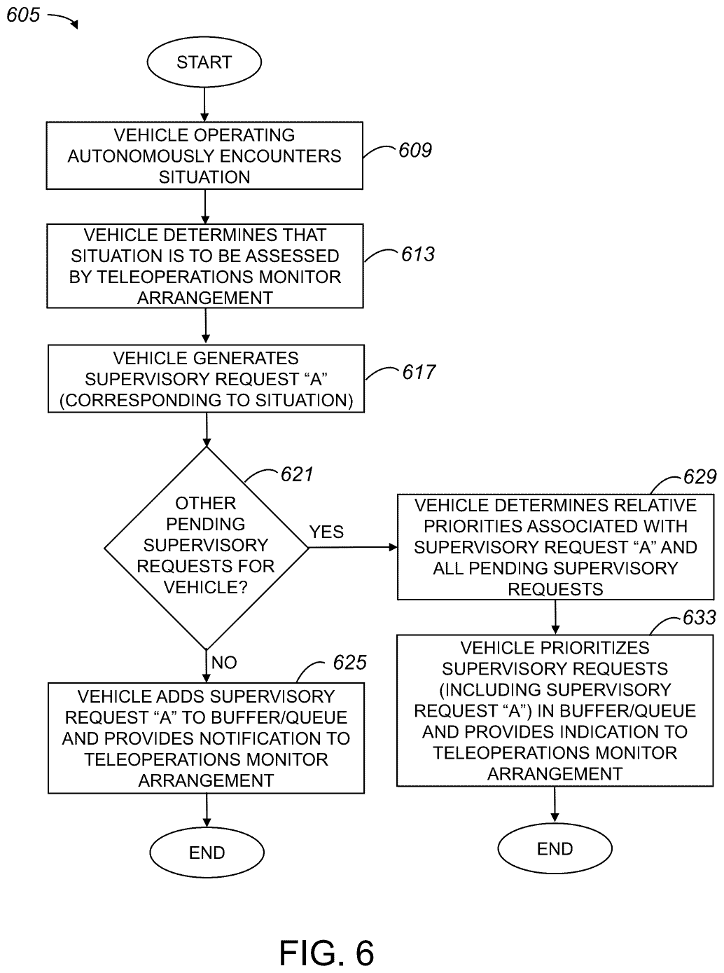

As discussed above, a vehicle may encounter more than one situation or issue for which the vehicle may request supervision or monitoring using a teleoperations monitor arrangement. In one embodiment, supervisory requests relating to the situations may be prioritized such that the highest priority supervisory request is processed or handled first by a teleoperations monitor arrangement. For example, a supervisory request for an issue that has a relatively high severity level may be a highest priority supervisory request that is handled, addressed, or accommodated before a supervisory request for an issue that has a relatively low severity level. FIG. 6 is a process flow diagram which illustrates a method of prioritizing supervisory requests associated with a vehicle in accordance with an embodiment. A method 605 of prioritizing supervisory requests associated with a vehicle begins at a step 609 in which a vehicle that is operating autonomously encounters a situation. The situation may be an unusual circumstance, or the situation may be a particular circumstance which the vehicle expects to encounter. For example, an unusual circumstance may arise when the vehicle identifies an unexpected obstacle along a route, and a particular circumstance which the vehicle expects to encounter may be a school zone.

Once the vehicle encounters a situation, the vehicle determines in a step 613 that the situation is one that is to be assessed by a teleoperations monitor using a teleoperations monitor arrangement. That is, the vehicle identifies the situation as one for which operation of the vehicle via teleoperations may be prudent.

After the vehicle identifies the situation as one to be assessed by a teleoperations monitor, process flow moves to a step 617 in which the vehicle generates a supervisory request that corresponds to the situation that was encountered or detected in step 609, e.g., supervisory request “A.”

In a step 621, a determination is made as to whether there are other pending supervisory requests for the vehicle. If the determination is that there are no other pending supervisory requests for the vehicle, the indication is that supervisory request “A” is the only pending supervisory request and, hence, the supervisory request with the highest priority. Accordingly, process flow moves to a step 625 in which the vehicle adds supervisory request “A” to a vehicle buffer or queue, and provides a notification to a teleoperations monitor arrangement. Upon adding supervisory request “A” to the buffer or queue, the method of prioritizing supervisory requests associated with a vehicle is completed.

Returning to step 621, if the determination is that there are other pending supervisory requests for the vehicle, then the implication is that the pending supervisory requests and supervisory request “A” are to be prioritized. As such, in a step 629. The vehicle determines relative priorities associated with supervisory request “A” and all pending supervisory requests. The relative priorities may be determined using any suitable criteria, and the more critical supervisory requests may be prioritized over less critical supervisory requests. Suitable criteria may include, but are not limited to including, whether the vehicle is likely to be involved in a collisions, whether the vehicle is likely to obstruct the flow of traffic, whether the vehicle is able to operate at all, and/or whether the vehicle is in an area that is identified as not conducive to autonomous operations. Types of collisions, obstructions, inability to operate, and/or areas that are not conducive to autonomous operations may have different priorities. By way of example, a potential collision between the vehicle and a vulnerable road user such as a pedestrian may be determined to be more critical than a potential collision between the vehicle and a stationary object.

Once the vehicle determines relative priorities for supervisory request “A” and all pending supervisory requests, the vehicle prioritizes the supervisory requests in a step 633. The prioritized supervisory requests are provided in a buffer or queue on the vehicle, and an indication is provided to a teleoperations monitor arrangement. In one embodiment, the indication is provided to a queue associated with the teleoperations monitor arrangement. The method of prioritizing supervisory requests associated with a vehicle is completed upon the supervisory requests being prioritized and the indication being provided to the teleoperations monitor arrangement.

The priorities of different supervisory requests may generally be selected by an enterprise which operates a fleet of autonomous vehicles and a teleoperations monitor arrangement. In other words, the priorities of different supervisory requests and, hence, issues identified in the supervisory requests, may vary depending upon the requirements or guidelines of an enterprise. By way of example, priorities may be ranked based on a type, with higher priority supervisory requests being prioritized to be dispatched for processing as soon as possible. In one embodiment, priorities may be assigned such that types collisions have the highest priority, followed by events relating to emergency vehicles, human traffic controllers such as road workers, and/or constrictions zones. For each type, the location of a vehicle may be used to prioritize supervisory requests having the same type, e.g., a supervisory request of a particular type that is initiated by a vehicle located in an intersection or is blocking traffic may have a higher priority than other supervisory requests of the same particular type.

In one embodiment, when a particular vehicle issues a new supervisory request and already has a pending supervisory request, an aggregated supervisory request may be generated which identifies both the new supervisory request and the pending supervisory request. The aggregated supervisory request may have an overall priority that is based on the highest priority associated with the new supervisory request and the pending supervisory request. The overall priority of the aggregated supervisory request is used to prioritize the aggregated supervisory request in a queue of supervisory requests. It should be appreciated that in lieu of generating an aggregated supervisory request, substantially every supervisory request associated with a particular vehicle may be processed with the highest priority supervisory request associated with the particular vehicle. In other words, after a highest priority supervisory request initiated by a vehicle is processed by a teleoperations monitor arrangement, approximately all other supervisory requests initiated by the vehicle may be processed by the teleoperations monitor arrangement before any supervisory request from a different vehicle is processed by the teleoperations monitor arrangement.

Referring next to FIG. 7, a method of a teleoperations system obtaining and processing a supervisory request associated with a vehicle, e.g., step 517 of FIG. 5, in accordance with an embodiment. Method 517 of obtaining and processing a supervisory request associated with a vehicle begins at a step 709 in which a teleoperations monitor arrangement obtains an indication of one or more supervisory request associated with a vehicle. The indication may be an indicator or flag in a queue associated with the teleoperations monitor which is arranged to effectively identify supervisory requests. In one embodiment, the indicator may include a pointer to a buffer or queue on the vehicle which contains a prioritized list of supervisory requests initiated from the vehicle.

After the teleoperations monitor arrangement obtains an indication, or otherwise determines that there is at least one supervisory request associated with a vehicle, the teleoperations monitor arrangement determines that it has the bandwidth to access the one or more supervisory requests associated with the vehicle in a step 713. That is, the teleoperations monitor arrangement is available to effectively process the one or more supervisory requests initiated by the vehicle.

In a step 717, the teleoperations monitor arrangement accesses the highest priority, as for example highest severity, supervisory request associated with the vehicle. In other words, the teleoperations monitor arrangement accesses the most critical supervisory request initiated by the vehicle. It should be appreciated that in the event that there are two or more supervisory requests associated with the vehicle, the highest priority supervisory request will typically be accessed by the teleoperations monitor arrangement.

From step 717, process flow moves to a step 721 in which the teleoperations monitor arrangement processes the highest priority supervisory request associated with the vehicle. Processing the supervisory request generally involves monitoring a situation identified in or by the supervisory request and ascertaining whether the situation is such that the vehicle may benefit from being operated using a teleoperations system.

Once the teleoperations monitor arrangement processes the highest priority supervisory request obtained from the vehicle, the teleoperations monitor arrangement takes appropriate action, or causes an appropriate action to be taken, in a step 725. An appropriate action may involve an assignment of a teleoperations system to take remote control of the vehicle and/or a notification to the vehicle to continue operating in an autonomous mode. Upon the teleoperations monitor arrangement either taking an appropriate action or causing an appropriate action to be taken, the method of obtaining and processing a supervisory request associated with a vehicle is completed.

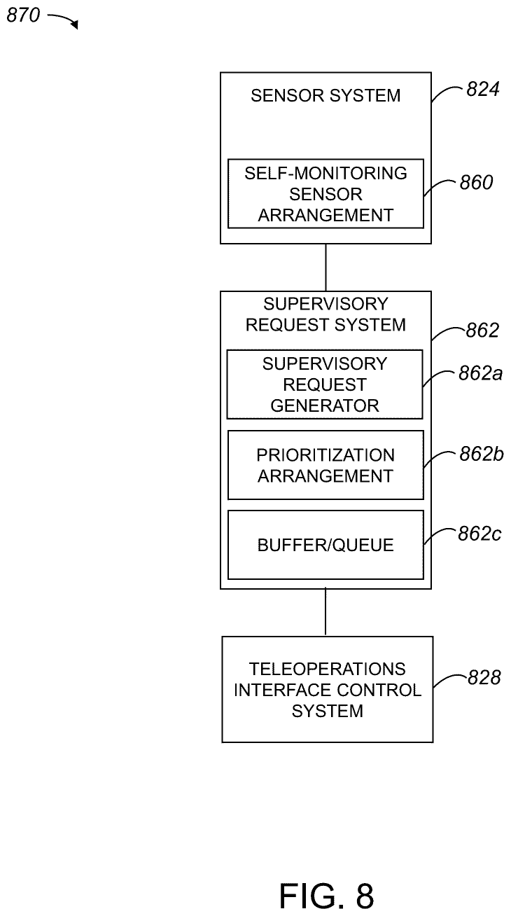

With reference to FIG. 8, an overall system that prioritizes supervisory requests for handling by a teleoperations monitor arrangement will be described in accordance with an embodiment. An overall system 840 that is part of an autonomous vehicle generally includes a sensor system 824, a supervisory request system 862, and a teleoperations interface control system 828. Sensor system 824 includes sensors generally used by an autonomy system. Such sensors include, but are not limited to including, cameras, lidars, radars, microphones, temperature sensors, speed sensors, acceleration sensors, altimeters, and/or ultrasonic sensors. Sensor system 824 also includes a self-monitoring sensor arrangement 860 which may include any suitable sensors that are capable of monitoring a vehicle and a surrounding environment to identify situations or anomalies which may result in the creation of a supervisory request.

Supervisory request system 862, which may be embodied as hardware and/or software logic embodied on a computer-readable medium, is arranged to process information obtained from self-monitoring sensor arrangement 860. Supervisory request system 862 includes a supervisory request generator 862a, a prioritization arrangement 862b, and a buffer or queue 862c.

Supervisory request generator 862a is configured to process information from self-monitoring sensor arrangement 860, and to create supervisory requests as appropriate. For example, if self-monitoring sensor arrangement 860 identifies an issue or a situation that supervisory request generator 862a determines would benefit from being monitored by a teleoperations monitor, supervisory request generator 862a may create a supervisory request that identifies the situation, and provides other contextual information which may be accessed by the teleoperations monitor.

Prioritization arrangement 862b may prioritize supervisory requests generated by supervisory request generator 862a. Any suitable method or algorithm may be used to prioritize supervisory requests, and factors considered when determining which types of supervisory requests take precedence, or are more critical to resolve, may vary widely. For example, supervisory requests relating to collisions or potential collisions may take priority over supervisory requests relating to a slightly elevated temperature of a component in a vehicle. In general, supervisory requests which involve injury or potential injury, or an inability for a vehicle to operate safely, may have the highest priority, while supervisory requests which are less likely to have an impact on the ability of a vehicle to operate safely may have a lower priority. Prioritization arrangement 862b may reprioritize all pending supervisory requests when a new supervisory request is created, although is should be appreciated that prioritization arrangement 862b may instead, or additionally, periodically reprioritize all pending supervisory requests.

Pending supervisory requests are stored in buffer or queue 862c. When a teleoperations monitor receives or otherwise obtains an indication that there are one or more supervisory requests stored in buffer or queue 862c, the indication may be, or may include, a pointer into buffer or queue 862c to the highest priority supervisory request. Buffer or queue 862c may be arranged to essentially identify the order in which supervisory requests stored therein are to be addressed, e.g., accessed and processed by a teleoperations monitor. As supervisory requests are processed and substantially resolved, supervisory requests may be removed from buffer or queue 862c.

Teleoperations interface control system 828 is configured to enable a vehicle to be controlled via teleoperations, or by a teleoperations system. Teleoperations interface control system 828 also allows a teleoperations monitor arrangement to access supervisory requests stored in buffer or queue 862c.

In one embodiment, a buffer/queue of supervisory requests may be arranged to contain multiple supervisory requests from one vehicle as well as supervisory requests from different vehicles of a fleet. The supervisory requests may be prioritized based on factors which include, but are not limited to including, a severity level of an issue, a type of vehicle, a type of mission or task that is in process, a length of a mission or task, a location of a vehicle, environmental conditions, road conditions, and/or an overall impact of an issue on a vehicle or an environment. For instance, the time at which a particular supervisory request is initiated or raised may be a factor in determining a priority of the supervisory request. By way of example, two supervisory requests which would otherwise have substantially the same priority based on a type may be prioritized based on when each of the supervisory requests was initiated such that the first supervisory requests that was initiated is queued for processing first.

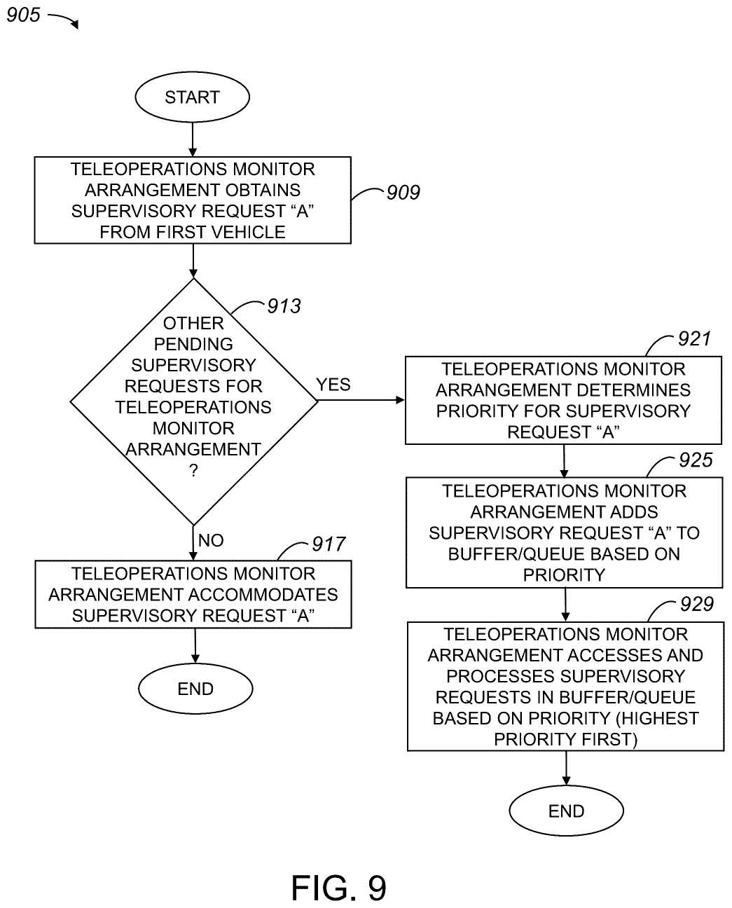

FIG. 9 is a process flow diagram which illustrates a method of a teleoperations monitor arrangement utilizing a buffer/queue of supervisory requests in accordance with an embodiment. A method 905 of a teleoperations monitor arrangement utilizing a buffer/queue in which supervisory requests are queued or otherwise stored begins at a step 909 in which a teleoperations monitor arrangement obtains a supervisory request “A” from a first vehicle. Supervisory request “A” may be created by the first vehicle when the first vehicle detects an issue, and may include a request to monitor or otherwise address the issue. That is, supervisory request “A” may include one or more indicators which indicate an issue detected by the vehicle and/or a request to monitor the vehicle for that particular issue.

A determination is made in a step 913 as to whether there are pending supervisory requests in addition to supervisory request “A” which are to be accommodated by a teleoperations monitor arrangement. In other words, it is determined whether the teleoperations monitor arrangement has other supervisory requests that are queued of handling.

If it is determined that there are no other pending supervisory requests, the teleoperations arrangement is able to accommodate supervisory request “A” in a step 917. As there are no other pending supervisory requests, a priority level for supervisory request “A” generally does not need to be determined, as supervisory request “A” may be substantially immediately accommodated. It should be appreciated, however, that a priority level for supervisory request “A” may be generated such that the teleoperations monitor arrangement may be aware of a severity level associated with the issue for which supervisory request “A” was generated. Once the teleoperations monitor arrangement accommodates supervisory request “A,” the method of a teleoperations monitor arrangement utilizing a buffer/queue is completed.

Alternatively, if it is determined in step 913 that there are other pending supervisory requests for the teleoperations monitor arrangement to handle, the indication is that supervisory request “A” is to be added to a buffer/queue of supervisory requests. As such, process flow moves from step 913 to a step 921 in which the teleoperations monitor arrangement determines a priority for supervisory request “A.” For example, the teleoperations monitor arrangement may assess a severity level of an issue identified in supervisory request “A,” and assign or otherwise identify a priority accordingly.

After the teleoperations monitor arrangement determines the priority for supervisory request “A,” the teleoperations monitor arrangement adds supervisory request “A” to the buffer/queue of supervisory requests in a step 925. Supervisory request “A” is added to the buffer/queue based on the priority assigned to supervisory request “A.” For example, if supervisory request “A” has a relatively high priority, supervisory request “A” may be added to the queue such that supervisory request “A” will be accommodated or processed before supervisory requests with relatively low priorities. If supervisory request “A” has substantially the same priority as at least one other supervisory request already in the buffer/queue, supervisory request “A” may be added to the buffer/queue sequentially after the other supervisory request with substantially the same priority.

In a step 929, the teleoperations monitor arrangement access and processes supervisory requests that are contained or stored in the buffer/queue based on the priorities of the supervisory requests. Typically, the highest priority supervisory requests may be processed first. Upon the teleoperations monitor arrangement accessing and processing supervisory requests, the method of a teleoperations monitor arrangement utilizing a buffer/queue is completed.

In one embodiment, supervisory requests may be reprioritized or otherwise reordered either periodically or upon a particular occurrence. For example, a supervisory request that is of a relatively low severity level may initially be assigned a low priority level, but may be substantially reprioritized to a higher priority level if the supervisory request has been queued for longer than a predetermined amount of time. That is, a particular supervisory request with a relatively low severity may be reprioritized to have a higher priority, even over other supervisory requests with a relatively high severity level, if a threshold amount of time in a queue has been substantially exceeded by the particular supervisory request.

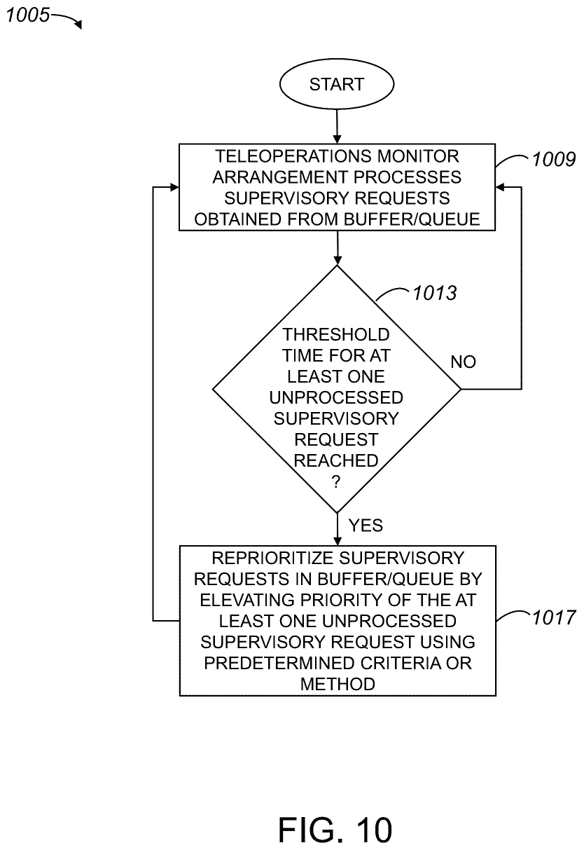

FIG. 10 is a process flow diagram which illustrates a method of reprioritizing supervisory requests in a buffer/queue in accordance with an embodiment. A method 1005 of reprioritizing supervisory requests begins at a step 1009 in which a teleoperations monitor arrangement processes supervisory requests obtained from a buffer/queue of supervisory requests.

In a step 1013, it is determined whether a threshold time for at least one unprocessed supervisory request has been reached. That is, a determination is made as to whether the buffer/queue includes at least one supervisory request that has not be processed or handled, and has been in the queue for a predetermined amount of time, e.g., and amount of time which indicates that the supervisory request is to be reprioritized.

If the determination is that the threshold time has not been reached for at least one unprocessed supervisory request, then process flow returns to step 1009 in which the teleoperations monitor arrangement continues to process supervisory requests. Alternatively, if it is determined that the threshold time for at least one unprocessed supervisory request has been reached, then in a step 1017, the supervisory requests in the buffer/queue are reprioritized. In one embodiment, the reprioritization of the supervisory requests may include elevating the priority of the unprocessed supervisory request which has been in the buffer/queue for the threshold time using a predetermined criteria or method. By way of example, in addition to considering the age of the unprocessed supervisory request which has been in the buffer/queue for the threshold time, the severity level of the unprocessed supervisory request may also be considered when determining a new priority for the unprocessed supervisory request. Once the supervisory requests in the buffer/queue are reprioritized by elevating the priority of the unprocessed supervisory request which has been in the buffer/queue for the threshold time, the method of reprioritizing supervisory requests is completed.

Although only a few embodiments have been described in this disclosure, it should be understood that the disclosure may be embodied in many other specific forms without departing from the spirit or the scope of the present disclosure. By way of example, supervisory requests have been described as being prioritized based on importance or criticality. In some embodiments, supervisory requests may alternatively or additionally be prioritized based on the amount of time the supervisory requests have been in a queue. A less critical supervisory request which has been queued for more than a threshold amount of time may be prioritized over a supervisory request that is considered to be more critical in some situations. In other words, a first supervisory request that is of a lower severity level than a second supervisory request may be prioritized over the second supervisory request in some situations when the first supervisory request has been queued for more than what may be considered to be an acceptable amount of time.

While a supervisory request that is in the process of being accommodated, e.g., when a teleoperations monitor is processing a supervisory request, that supervisory request is generally resolved before the teleoperations monitor obtains another supervisory request for processing from a buffer/queue. However, in some situations, when a supervisory request that is currently being processed by a teleoperations monitor that is part of a system has a relatively low priority, e.g., has a relatively low severity level, and a supervisory request with a substantially highest priority and severity level effectively comes into the system, the teleoperations monitor may pause processing of the relatively low priority supervisory request in order to process the substantially highest priority supervisory request.

When a teleoperations monitor is suitable for monitoring multiple vehicles, the priorities of the supervisory requests associated with each of the vehicles may be used to determine which vehicle the teleoperations monitor is to service or monitor first. That is, the priorities associated with supervisory requests of multiple vehicles may be considered when determining which supervisory request the teleoperations monitor may handle first.

In one embodiment, an overall system may include multiple teleoperations monitors which may effectively share a buffer/queue of supervisory requests. When a system includes multiple teleoperations monitors, multiple substantially highest priority supervisory requests may effectively be handled at the same time, as each teleoperations monitor may process a substantially highest priority supervisory request obtained from a buffer/queue.

A supervisory request initiated by a vehicle may, as mentioned above, have a priority for processing or servicing that is determined by the vehicle. In one embodiment, the vehicle may initiate a supervisory request and the supervisory request may be added to a queue for processing substantially immediately after the supervisory request is received, e.g., received on a backend such as a teleoperations monitor arrangement that is in communication with a queue. A teleoperations monitor arrangement may be used to process the highest priority supervisory request in a queue.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner. Additionally, while an autonomous vehicle that is configured to deliver and pick up goods has generally been described, an autonomous vehicle in may be arranged to carry occupants, as for example passengers, without departing from the spirit or the scope of the disclosure.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining a first supervisory request from a first vehicle, the supervisory request being a request to monitor the first vehicle;
determining whether to determine a priority level for the first supervisory request;
when it is determined that the priority level for the first supervisory request is not to be determined, processing the first supervisory request, wherein the first supervisory request is processed by a teleoperations monitor arrangement;
when it is determined that the priority level for the first supervisory request is to be determined, determining a first priority for the first supervisory request;
after determining the first priority, adding the first supervisory request to a queue according to the first priority, the queue including at least a second supervisory request having a second priority; and
determining whether the first priority is higher than the second priority, wherein when it is determined that the first priority is higher than the second priority, processing the first supervisory request before the second supervisory request, the first supervisory request being obtained from the queue by the teleoperations monitor arrangement and processed by the teleoperations monitor arrangement, wherein processing the first supervisory request includes determining whether the first vehicle is to be remotely operated by the teleoperations operator arrangement.

2. The method of claim 1 wherein processing the first supervisory request further includes determining whether the first vehicle is to operate autonomously.

3. The method of claim 1 further including:
obtaining the second supervisory request from the first vehicle before obtaining the first supervisory request from the first vehicle.

4. The method of claim 3 wherein the queue further includes a third supervisory request, the third supervisory request being associated with a second vehicle.

5. The method of claim 1 further including:
determining whether at least one of the first supervisory request and the second supervisory request are in the queue after a threshold amount of time has elapsed; and
reprioritizing the second supervisory request with respect to the first supervisory request when it is determined that the second supervisory request is in the queue after the threshold amount of time has elapsed.

6. The method of claim 5 wherein a first severity level of the second supervisory request is lower than a second severity level of the first supervisory request.

7. The method of claim 1 wherein when it is determined that the first vehicle is to be remotely operated by the teleoperations operator arrangement, the method further includes:
adding an indication of the first vehicle to a teleoperations operator queue; and
providing a notification to the first vehicle that the first vehicle is to be remotely operated by the teleoperations operator arrangement.

8. A platform comprising:
at least a first vehicle; and
an apparatus, the apparatus including
one or more processors, and
one or more memory resources storing logic that, when executed by the one or more processors, is operable to cause the platform to
obtain a first supervisory request from the first vehicle, the supervisory request being a request to monitor the first vehicle,
determine whether to determine a priority level for the first supervisory request,
when it is determined that the priority level for the first supervisory request is not to be determined, process the first supervisory request, wherein the first supervisory request is processed by a teleoperations monitor arrangement, and wherein the logic operable to process the first supervisory request includes logic operable to determine whether the first vehicle is to be remotely operated by a teleoperations operator arrangement,
when it is determined that the priority level for the first supervisory request is to be determined, determine a first priority for the first supervisory request, and
after the first priority is determined, add the first supervisory request to a queue according to the first priority, the queue including at least a second supervisory request having a second priority, and
determine whether the first priority is higher than the second priority, wherein when it is determined that the first priority is higher than the second priority, process the first supervisory request before the second supervisory request, the first supervisory request being obtained from the queue by the teleoperations monitor arrangement and processed by the teleoperations monitor arrangement, wherein the logic operable to process the first supervisory request includes logic operable to determine whether the first vehicle is to be remotely operated by the teleoperations operator arrangement.

9. The platform of claim 8 wherein the logic operable to process the first supervisory request is further operable to determine whether the first vehicle is to operate autonomously.

10. The platform of claim 8 further including logic operable to obtain the second supervisory request from the first vehicle before obtaining the first supervisory request from the first vehicle.

11. The platform of claim 10 further including a second vehicle, and wherein the queue further includes a third supervisory request, the third supervisory request being associated with the second vehicle.

12. The platform of claim 8 wherein the logic is further operable to:
determine whether at least one of the first supervisory request and the second supervisory request are in the queue after a threshold amount of time has elapsed; and
reprioritize the second supervisory request with respect to the first supervisory request when it is determined that the second supervisory request is in the queue after the threshold amount of time has elapsed.

13. The platform of claim 12 wherein a first severity level of the second supervisory request is lower than a second severity level of the first supervisory request.

14. The platform of claim 8 wherein when it is determined that the first vehicle is to be remotely operated by the teleoperations operator arrangement, the logic is further operable to:
add an indication of the first vehicle to a teleoperations operator queue; and
provide a notification to the first vehicle that the first vehicle is to be remotely operated by the teleoperations operator arrangement.

15. An apparatus comprising:
a processor,
a memory, the memory including a queue; and
one or more tangible non-transitory, computer-readable medium having logic encoded thereon, wherein the logic, when executed by the processor, is operable to
obtain a first supervisory request from a first vehicle, the supervisory request being a request to monitor the first vehicle,
determine a first priority for the first supervisory request,
add the first supervisory request to the queue based on the first priority, wherein the queue includes at least a second supervisory request, the second supervisory request having a second priority,
when the first priority is higher than the second priority, select the first supervisory request for processing before the second supervisory request, wherein the logic operable to select the first supervisory request for processing is further operable to process the first supervisory request by determining whether the first vehicle is to be remotely operated by the teleoperations operator arrangement, and
when it is determined that the first vehicle is to be remotely operated by the teleoperations operator arrangement, provide a first notification to the teleoperations operator arrangement and the first vehicle, the first notification being arranged to indicate that the teleoperations operator arrangement is to remotely operate the first vehicle.

16. The apparatus of claim 15 wherein the logic is further operable to:
determine when a length of time the second supervisory request is in the queue meets a threshold amount of time;
when it is determined that the length of time meets the threshold amount of time, determine a new priority for the second supervisory request, the new priority being higher than the second priority, and
after the new priority is determined, reorder the second supervisory request and the first supervisory request in the queue based on the new priority.

17. The apparatus of claim 16 wherein the first supervisory request has a first severity level and the second supervisory request has a second severity level, and wherein the first severity level is higher than the second severity level.

18. The apparatus of claim 15 wherein the first supervisory request includes a first indication of an issue with the first vehicle, and the request to monitor the vehicle includes an instruction to monitor the issue.

19. The apparatus of claim 15 wherein the second supervisory request is associated with the first vehicle.

20. The apparatus of claim 15 wherein the logic is further operable to:
when it is determined that the first vehicle is not to be remotely operated by the teleoperations operator arrangement, provide a second notification to the first vehicle, the second notification being arranged to indicate that the first vehicle is to operate autonomously.
